(19) United States
(12) Patent Application Publication
(10) Pub. No.: US 2013/0063240 A1
(43) Pub. Date: Mar. 14, 2013

(54) TRANSFORMER

(71) Applicants: Hiroshi IMADA, NAGANO (JP); Hideharu KANAMITSU, NAGANO (JP); Masataka SUZUKI, NAGANO (JP)

(72) Inventors: Hiroshi IMADA, NAGANO (JP); Hideharu KANAMITSU, NAGANO (JP); Masataka SUZUKI, NAGANO (JP)

(73) Assignee: MINEBEA CO., LTD., KITASAKU-GUN (JP)

(21) Appl. No.: 13/609,662

(22) Filed: Sep. 11, 2012

(30) Foreign Application Priority Data
Sep. 14, 2011 (JP) 2011-200324

(51) Int. Cl. H01F 27/28

(52) U.S. Cl. 336/220

(57) ABSTRACT

A transformer includes: a core portion, which forms a magnetic circuit; a coil bobbin, which has a winding core portion to be wound by a winding wire, and which is attached on the core portion; a primary winding wire, which has a plurality of first divided winding wire portions divided in parallel; and a secondary winding wire, which has a plurality of second divided winding wire portions divided in parallel, wherein the plurality of first divided winding wire portions and the plurality of second divided winding wire portions are layered on the winding core portion, wherein at least one of the first divided winding wire portions becomes a first layer which is closest to the winding core portion, and at least one of the other of the first divided winding wire portions is interposed between two of the second divided winding wire portions.

### CROSS-REFERENCE TO RELATED APPLICATION

This application claims priority from Japanese Patent Application No. 2011-200324 filed on Sep. 14, 2011, the entire subject matter of which is incorporated herein by reference.

### TECHNICAL FIELD

This disclosure relates to a transformer, and more specifically, to a transformer has a primary winding wire and a secondary winding wire, which are respectively divided in parallel to form winding wire portions.

### BACKGROUND

One of transformers for use in a power supply circuit of electronics has a structure having a primary winding and a secondary winding which are respectively divided in parallel. The transformer having this structure generally includes a structure, in which a pair of windings that is divided into a primary side and a secondary side in parallel is simultaneously wound around a coil bobbin (the structure is also referred to as bifilar winding)).

FIG. 7 illustrates one example of the transformer of the background art.

As illustrated in FIG. 7, a transformer 80 broadly is configured by a coil bobbin 82 wound by a winding wire 83 and two E-shaped cores 81 interposing the bobbin 82. Middle magnetic legs of the two cores 81 penetrate the coil bobbin 82. The winding wire 83 has a primary winding P8 and a secondary winding S8. The primary winding P8 is divided into two divided windings P81 and P82, which are connected in series to each other. The secondary winding S8 is divided into two divided windings S81 and S82, which are connected in parallel to each other.

The primary winding P8 is wound around a winding core portion 82a of the coil bobbin 82. In this instance, the divided winding P81 and the divided winding P82 are simultaneously wound with a pair. The secondary winding S8 is wound around an outer circumference of the primary winding P8, with an insulation part being interposed therebetween. In this instance, the divided winding S81 and the divided winding S82 are simultaneously wound around the winding core portion 82a with a pair. An outer circumference of the secondary winding S8 is also covered by the insulation part 85.

In the transformer of the background art, however, there is a problem in that when switching operation at the primary side is performed, a surge voltage is generated by leakage inductance of the transformer, so that noise such as irradiation noise or conduction noise is increased.

In view of the above, there is a transformer having a winding structure to suppress the leakage inductance (e.g., JP-A-2009-272438).

In JP-A-2009-272438, a transformer is disclosed, in which an axial distance of the bobbin from a flange portion of the bobbin to the respective primary and secondary windings is defined by a barrier tape

### SUMMARY

However, the transformer disclosed in JP-A-2009-272438 has a problem as follows. That is, in the transformer disclosed in JP-A-2009-272438, a relationship between an end portion of the winding and the flange portion of the bobbin in an axial direction of the bobbin is defined, but the configuration of the primary winding and the secondary winding in a diameter direction of the bobbin (layer configuration) is not specifically defined. For this reason, in the transformer disclosed in JP-A-2009-272438, there is a case where the leakage inductance is not sufficiently reduced according to the layer configuration.

Accordingly, this disclosure provides at least a transformer capable of lowering leakage inductance and suppressing generation of surge voltage to reduce noise.

With taking into consideration the above, a transformer of this disclosure comprises: a core portion, which forms a magnetic circuit; a coil bobbin, which has a winding core portion to be wound by a winding wire, and which is attached on the core portion; a primary winding wire, which has a plurality of first divided winding wire portions that is divided in parallel; and a secondary winding wire, which has a plurality of second divided winding wire portions that is divided in parallel, wherein the plurality of first divided winding wire portions and the plurality of second divided winding wire portions are layered on the winding core portion, wherein at least one of the first divided winding wire portions becomes a first layer which is closest to the winding core portion, and at least one of the other of the first divided winding wire portions is interposed between two of the second divided winding wire portions.

In the above-described transformer, the number of the first divided winding wire portions may be the same as the number of the second divided winding wire portions, and each one of first divided winding wire portions and each one of second winding wire portions may be alternatively layered.

In the above-described transformer, at least one of the primary winding wire and the secondary winding wire may include a series winding wire portion, which is connected in series to at least one of the first winding wire portion of the primary winding wire and the second winding wire portion of the secondary winding wire, and the series winding wire portion may be layered at an outer side of the plurality of first divided winding wire portions and the plurality of first divided winding wire portions.

The above-described transformer may further comprises: an auxiliary winding portion, which is provided to at least one of a primary side and a secondary side, and the auxiliary winding portion may be layered at an outer side of the plurality of first divided winding wire portions and the plurality of first divided winding wire portions.

According to this disclosure, the plurality of first divided winding wire portions of the primary winding wire and the plurality of second divided winding wire portions of the secondary winding wire, which are respectively divided in parallel, are layered on the winding core portion, and then at least one of the first divided winding wire portions becomes a first layer that is closest to the winding core portion, and at least one of the other of the first divided winding wire portions is interposed between two of the second divided winding wire portions. Accordingly, the transformer capable of lowering leakage inductance, suppressing generation of a surge voltage, and reducing noise can be provided.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a perspective view illustrating a transformer according to a first embodiment of this disclosure;

FIG. 2 illustrates a connection structure of a winding wire portion of the transformer;

FIG. 3 illustrates a winding structure of a winding wire portion of the transformer;

FIG. 4 illustrates a connection structure of a winding wire portion of a transformer according to a second embodiment of this disclosure;

FIG. 5 illustrates a winding structure of a winding wire portion of the transformer;

FIG. 6 illustrates a winding structure of a winding wire portion of a transformer according to one modification of the first embodiment; and

FIG. 7 illustrates one example of the transformer of the background art.

### DETAILED DESCRIPTION

Next, a transformer according to one embodiment of this disclosure will be described.

### First Embodiment

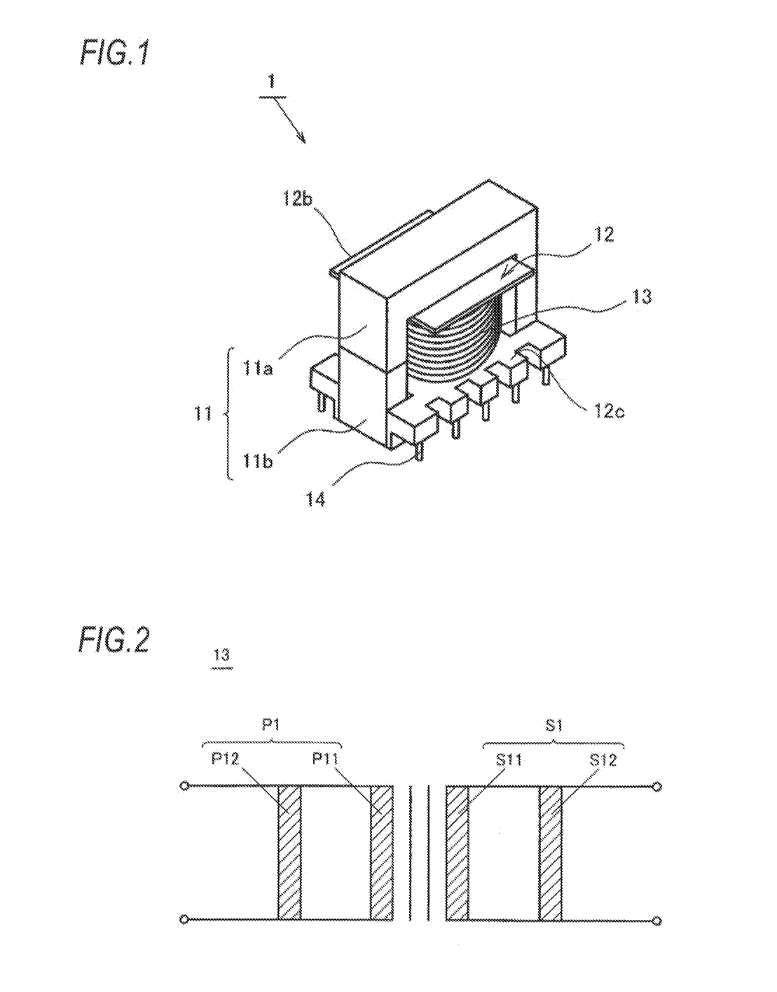

FIG. 1 is a perspective view illustrating a transformer 1 according to a first embodiment of this disclosure.

As illustrated in FIG. 1, the transformer 1 is, for example, a vertical switching transformer. The transformer 1 includes a core portion 11, a coil bobbin 12, a winding wire portion 13, and a plurality of shear pins 14.

The core portion 11 includes two cores 11a and 11b. Each of the cores 11a and 11b is formed in a so-called E-shape having a yoke portion and three magnetic legs extending from the yoke portion. The cores 11a and 11b are placed so that the magnetic legs are face to each other. The core portion 11 is made from a magnetic material to form a magnetic circuit.

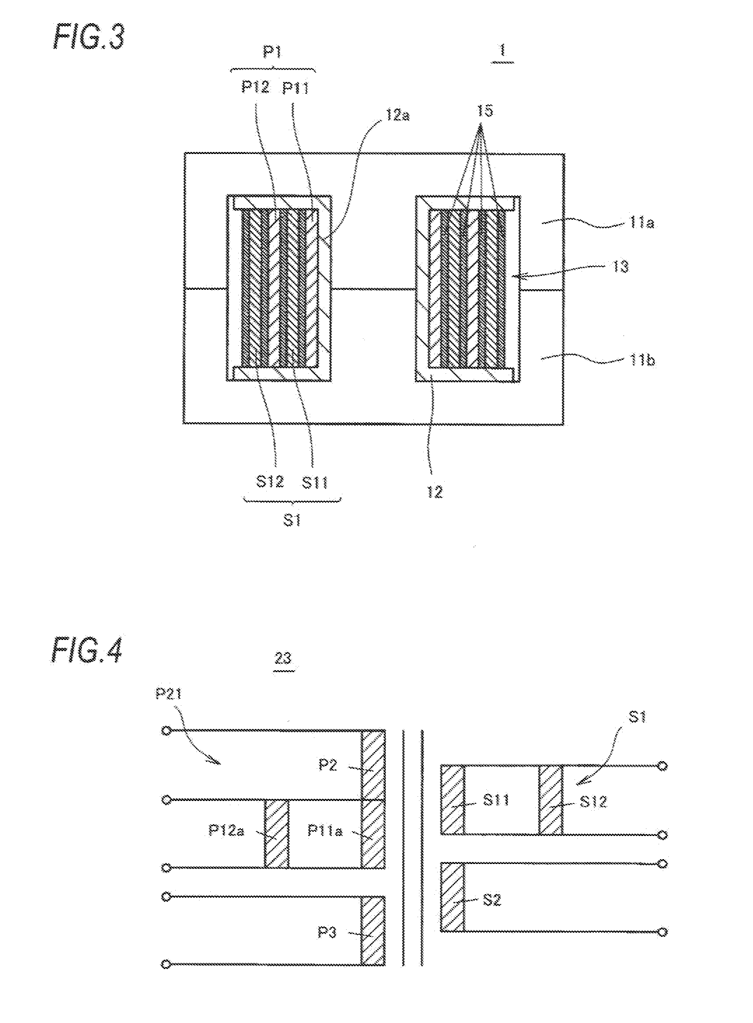

The coil bobbin 12 includes, for example, a tubular wound portion, which has a winding core portion 12a (illustrated in FIG. 3) with a winding wire wound around its outer circumference and flange portions 12b and 12c (one flange 12c becomes a mount portion) provided on both end portions. The winding wire portion 13 is wound around the winding core portion 12a of the coil bobbin 12. The mount portion (flange portion 12c) of the coil bobbin 12 is provided with a plurality of bundle pins 14. One end portion of the respective bundle pins 14 is embedded in the mount portion. An end portion of the winding wire portion 13 is sheaved and connected to the respective bundle pins 14.

The coil bobbin 12 wound by the winding wire portion 13 is mounted and assembled to the core portion 11. The coil bobbin 12 is attached to the core portion 11 so that middle magnetic legs (also referred to as middle legs) of the respective cores 11a and 11b are abutted and inserted into a hole portion penetrating the winding core portion 12a.

FIG. 2 illustrates a connection structure of a winding wire portion of the transformer.

As illustrated in FIG. 2, the winding wire portion 13 includes a primary winding P1 and a secondary winding S1. The primary winding P1 is divided in parallel into two sections having the same number of turns, that is, parallel-divided winding wire portions P11 and P12 (one example of the first divided winding wire portion). The secondary winding S1 is divided in parallel into two sections having the same number of turns, that is, parallel-divided winding wire portions S11 and S12 (one example of the second divided winding wire portion).

The reason why the primary winding P1 and the secondary winding S1 are respectively divided in parallel is, for example, as follows. That is, when two divided windings are configured to have the same number of turns as that of the winding which is not divided and when the diameter of the two divided windings which are overlapped and wound is set to equal to that of the winding which is not divided, the divided windings is to be utilized a conductive wire finer than a conductive wire utilized for the winding which is not divided. For this reason, since a surface area of the two divided windings is increased relative to a surface area of the winding, which is not divided, a larger current can flow in the two divided windings due to a skin effect. Further, when the same current flows, the winding having the larger surface area can reduce heat generation due to the skin effect, so that the increase in temperature of the transformer 1 is lowered.

FIG. 3 illustrates the winding structure of the winding wire portion 13 of the transformer 1.

Specifically, FIG. 3 illustrates a schematic cross-sectional view in a plane passing a wound center of the winding wire portion 13 of the transformer 1, but the mount portion of the voice coil bobbin 12 or the binding pin 14 are not illustrated. In addition, hereinafter, the drawings illustrating the winding structure is also schematically illustrated in the same way.

As illustrated in FIG. 3, the winding wire portion 13 has a multi-layered structure including four layers (excluding an insulation member 15 which will be described later). The winding wire portion 13 is configured by layering of four of primary/secondary parallel-divided winding wire portions P11, P12, S11 and S12 with the insulation member 15 on the winding core portion 12a. That is, the winding wire portion 13 has the structure in which the parallel-divided winding wire portions P11, P12, S11 and S12 are layered on the winding core portion 12a.

The winding wire portion 13 is configured such that one parallel-divided winding wire portion P11 of the primary winding P1 becomes a first layer which is closest to the winding core portion 12a, and the parallel-divided winding wire portions P11 and P12 of the primary winding P1 and the parallel-divided winding wire portions S11 and S12 of the secondary winding S1 are alternatively layered on the winding core portion 12a. That is, the parallel-divided winding wire portion P11 of the primary winding P1 becomes the first layer that is closest to the middle magnetic leg of the core portion 11. The winding wire portion 13 has a layered structure, in which it is wound on the winding core portion 12 from the inside to outside in order of the parallel-divided winding wire portion P11 of the primary winding P1, the parallel-divided winding wire portion S11 of the secondary winding S1, the parallel-divided winding wire portion P12 of the primary winding P1, and the parallel-divided winding wire portion S12 of the secondary winding S1a. In other words, the winding wire portion 13 has the layered structure in which the respective parallel-divided winding wire portions P11 and P12 of the primary side are adjacent to at least one of the parallel-divided winding wire portions S11 and S12 of the secondary side.

The respective layers of the winding wire portion 13 is layered with interposing the insulation member 15 therebetween. Also, the outermost layer of the winding wire portion 13, that is, the outside of the parallel-divided winding wire portion S12 is wound by the insulation member 15. The insulation member 15 is, for example, an insulation tape.

In this embodiment, the parallel-divided winding wire portions P11 and P12 of the primary winding P1 and the parallel-divided winding wire portions S11 and S12 of the secondary winding S1 are provided as the same number (that is two). Also, each one of the two parallel-divided winding wire portions P11 and P12 and each one of the two parallel-divided winding wire portions S11 and S12 are alternatively layered on the winding core portion 12a. One parallel-divided winding wire portion P12 of the primary winding P1 is interposed between the layers of the two parallel-divided winding wire portions S11 and S12 of the secondary winding S1. Also, one parallel-divided winding wire portion S11 of the secondary winding S1 is interposed between the two parallel-divided winding wire portions P11 and P12 of the primary winding P1.

Since the winding wire portion 13 has the above layer configuration, leakage inductance of the transformer 1 is remarkably reduced, as compared to the structure of the background art. There are factors leading to the effect, for example, (1) to (3) below. In this embodiment, a synergistic effect of these factors is obtained.

(1) When the distance between the pair of the primary winding P1 and the secondary winding S1 to the center axis (center portion) of the core portion is shortened, the leakage inductance is reduced. In the transformer 1 of this embodiment, any one of the pair of the primary winding P1 and the secondary winding S1 configures the first layer parallel-divided winding wire portion P11 and the second layer parallel-divided winding wire portion S11. That is, the distance between the pair of the primary winding P1 and the secondary winding S1 and the center axis of the core portion 11 is about half of that of a winding wire portion of two-layered structure configuring the primary winding P1 and the secondary winding S1 which is not divided, like the background art.

(2) The transformer 1 has the layer configuration, in which the parallel-divided winding wire portions P11 and P12 of the primary winding P1 and the parallel-divided winding wire portions Sll and S12 of the secondary winding S1 are alternatively layered. The area (facing area), in which the primary winding P1 and the secondary winding S1 faces to each other, is increased, as compared to the facing area of the configuration, like the background art.

(3) The distance between the respective parallel-divided winding wire portions P11, P12, S11 and S12 of the primary winding P1 and the secondary winding S1 becomes closer. That is, the distance between the parallel-divided winding wire portion P11 and the parallel-divided winding wire portions S11, the distance between the parallel-divided winding wire portion S11 and the parallel-divided winding wire portions P12, and the distance between the parallel-divided winding wire portion P12 and the parallel-divided winding wire portions S12 is shorten, respectively.

As described above, the transformer 1 is capable of reducing the leakage inductance, as compared to the structure of the background art. Accordingly, it is possible to suppress surge voltage at switching operation, thereby reducing generation of noise such as irradiation noise and conduction noise.

Also, since the leakage inductance is reduced, a reactive current flowing in a switching element, which enables the current to flow in the transformer 1, is lowered. Accordingly, when the transformer 1 is utilized in a power supply apparatus or the like, the heat generation of the switching element or other circuit elements is suppressed, thereby decreasing a switching loss of the power supply apparatus or the like. Further, since the surge voltage is suppressed, a switching element having relatively low pressure-resistant can be utilized. Accordingly, a component cost of the apparatus employing the transformer 1 is decreased, thereby lowering a manufacturing cost.

In this embodiment, the parallel-divided winding wire portion P11 of the primary winding P1 becomes the first layer which is closest to the middle magnetic leg of the core portion 11. Accordingly, the primary winding, which becomes the source of generating the switching noise, is positioned at inner side of the winding wire portion 13, so that the noise is unlikely to discharge. Accordingly, it is possible to more effectively reduce the noise.

### Second Embodiment

The fundamental configuration of a transformer according to the second embodiment is similarly to that of the first embodiment, and the overlapped description thereof will be omitted. A transformer 20 of the second embodiment is different from the first embodiment in that other winding wire portion 23 having a configuration different from the winding wire portion 13 is provided.

FIG. 4 illustrates a connection structure of the winding wire portion 23 of the transformer 20 according to the second embodiment of this disclosure.

As illustrated in FIG. 2, the winding wire portion 23 includes a primary winding P21, a primary auxiliary winding portion P3, a secondary winding S1, and a secondary auxiliary winding portion S2. The primary winding P21 and the primary auxiliary winding portion P3 are provided at a primary side. The secondary winding S1 and the secondary auxiliary winding portion S2 are provided at a secondary side. The secondary winding S1 is configured so that the parallel-divided winding wire portions P11 and P12 are connected in parallel to each other, similarly to the first embodiment.

The primary winding P21 has two parallel-divided winding wire portions (one example of the first divided winding wire portion) P11a and P12a which are divided in parallel into two sections having the same number of turns, and a series winding wire portion P2 which is connected in series to the parallel-divided winding wire portions P11a and P12a. In other words, it may be said that the primary winding P21 is configured as follows. That is, one winding wire is divided into two sections in series, and one of the two sections is the series winding wire portion P2. Also, the other of the two series-divided sections is further divided into two sections to have the same number of turns in parallel to form the parallel-divided winding wire portions P11a and P12a.

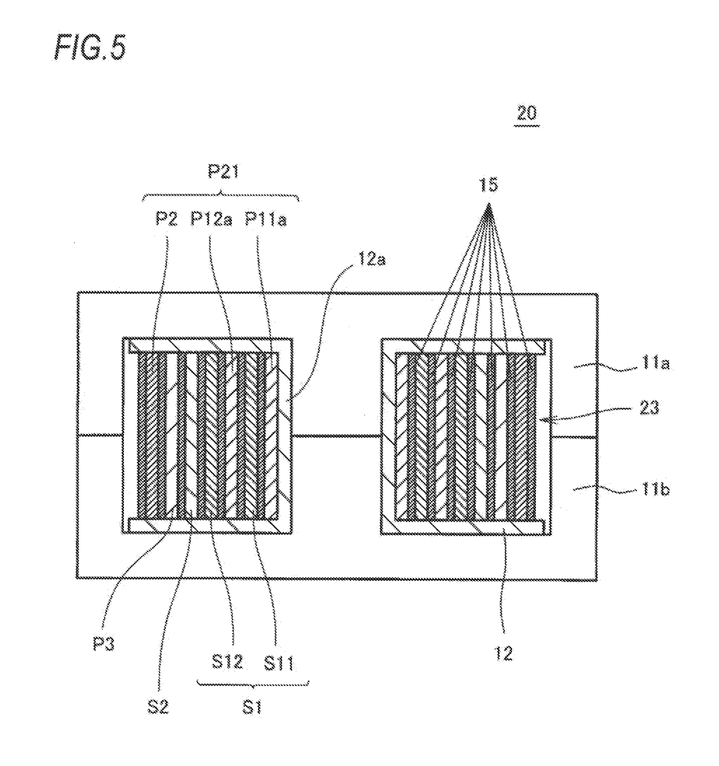

FIG. 5 illustrates a winding structure of the winding wire portion 23 of the transformer 20.

As illustrated in FIG. 5, the winding wire portion 23 has a multi-layered structure including seven layers (excluding the insulation member 15). The primary/secondary parallel-divided winding wire portions P11a, P12a, S11 and S12 with the insulation member 15, the series winding wire portion P2, the primary auxiliary winding portion P3, and the secondary auxiliary winding portion S2 are layered on the winding core portion 12a, so that the winding wire portion 23 is configured.

In the second embodiment, the series winding wire portion P2, the primary auxiliary winding portion P3, and the secondary auxiliary winding portion S2 are layered at the outside of the parallel-divided winding wire portions P11a, P12a, S11 and S12.

More specifically, the first layer through the fourth layer of the winding wire portion 23 (in order of closing to the winding core portion 12a) are configured so that the parallel-divided winding wire portions P11a and P12a of the primary winding P21 and the parallel-divided winding wire portions S11 and S12 of the secondary winding S1 are alternatively layered on the winding core portion 12a. In the winding wire portion 23, the parallel-divided winding wire portion P11a of the primary winding P21 becomes the first layer which is closest to the winding core portion 12a. That is, the winding structure of the primary/secondary parallel-divided winding wire portions P11a, P12a, S11 and S12 according to the second embodiment is identical to that of the parallel-divided winding wire portions P11, P12, S11 and S12 according to the first embodiment.

The second auxiliary winding portion S2, the primary auxiliary winding portion P3 and the series winding wire portion P2 are layered in that order, at an outside of the fifth layer of the winding wire portion 23 of the parallel-divided winding wire portion S12. Meanwhile, the layered order of the secondary auxiliary winding portion S2, the primary auxiliary winding portion P3, and the series winding wire portion P2 is not limited thereto, and the order may be appropriately changed.

In the transformer 20 according to the second embodiment, the layer configuration of the parallel-divided winding wire portions P11a, P12a, S11 and S12 is similarly to the layer configuration of the first embodiment. Accordingly, the effect of reducing the leakage inductance is also achieved similarly to the first embodiment.

In the second embodiment, the primary winding P21 is provided with the series winding wire portion P2. Accordingly, the number of turns in the parallel-divided winding wire portions P11a and P12a is decreased, as compared to the case in which the primary winding having the same number of turns is not provided with the series winding wire portion P2. When the primary winding P21 is configured as the above, the distance between the center axis of the core portion 11 and the pair of the primary winding 21 and the secondary winding S1, which are formed by the parallel-divided winding wire portion P11a and the parallel-divided winding wire portions S11, is further decreased, as compared to the first embodiment. Accordingly, the leakage inductance is further reduced, and thus the noise can be reduced.

The Others

This disclosure is not limited to a so-called vertical configuration, in which the center axis of the bobbin is vertical to a mounting surface such as the above-described embodiments, and will be applied to, for example, a horizontal configuration, in which the axis of the bobbin is parallel with the mounting surface.

With respect to the respective primary winding and the secondary winding, the number of the parallel-divided winding wire portions is not limited to two. For example, the primary winding and the secondary winding may be divided into three sections, respectively.

The number of turns in the parallel-divided windings may be different between the primary winding and the secondary winding. For example, the number of parallel-divided winding wire portions in the primary side is three, and the number of parallel-divided winding wire portions in the secondary side is two. That is, the primary winding is divided into three sections in parallel to have three parallel-divided winding wire portions, and the secondary winding may be divided into two sections in parallel to have two parallel-divided winding wire portions, and vice versa.

If the number of the parallel-divided winding wire portions is, for example, two for the primary side and three for the secondary side, each parallel-divided winding wire portion may be arranged in order of the primary, the secondary, the primary, the secondary, and the secondary sides. In this instance, the parallel-divided winding wire portions of the secondary side at the outer layer can be regarded as the same as one parallel-divided winding wire portion that is not divided, and thus the effect of reducing the leakage inductance is achieved, as compared to the structure of the background art.

As described above, this disclosure is not limited to the above-described configuration, in which the parallel-divided winding wire portions of the primary winding and the secondary winding are alternatively layered such as the above-described embodiments. That is, if one parallel-divided winding wire portion of the primary side becomes the first layer that is closest to the winding core portion and each of the other parallel-divided winding wire portions of the primary side is interposed between layers of the two parallel-divided winding wire portions of the secondary side, the leakage inductance can be reduced to achieve the effect of reducing the noise.

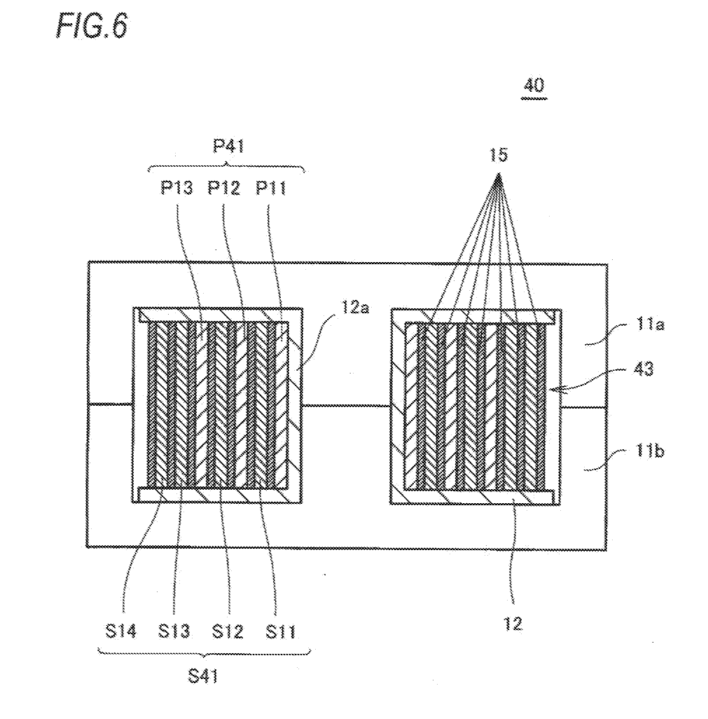

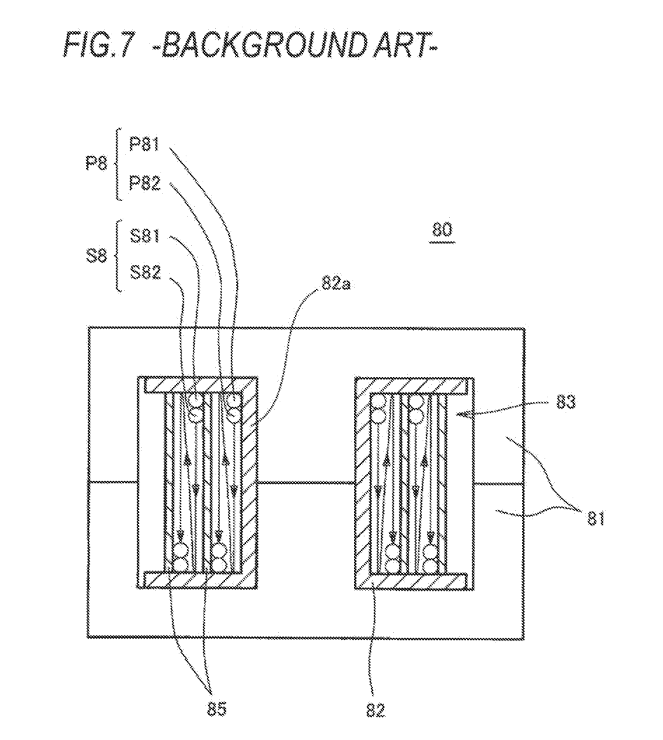

FIG. 6 illustrates a winding structure of a winding wire portion 43 of a transformer 40 according to one modification of the first embodiment described above.

As illustrated in FIG. 6, the winding wire portion 43 of the transformer 40 includes a seven-layered structure. The winding wire portion 43 includes a primary winding P41 and a secondary winding S41. The primary winding P41 is divided into three parallel-divided winding wire portions P11, P12 and P13 (hereinafter, also referred to as a primary side P11, a primary side P12 and a primary side P13), each of which has the same number of turns in parallel. The secondary winding S41 is divided into four parallel-divided winding wire portions S11, S12, S13 and S14 (hereinafter, also referred to as a secondary side S11, a secondary side S12, a secondary side S13 and a secondary side S14), each of which has the same number of turns in parallel.

The winding wire portion 43 is layered, from the first layer that is closest to the winding core portion 12a of the coil bobbin 12 to the outside, in order of the primary side P11, the secondary side S11, the primary side P12, the secondary side S12, the primary side P13, the secondary side S13, and the secondary side S14. That is, the primary side P12 is interposed between the secondary side S11 and the secondary side S12, and the primary side P13 is interposed between the secondary side S12 and the secondary side S13. Therefore, the effect of reducing the noise is also achieved by the transformer 40, like the above-described embodiments.

In the second embodiment described above, the series winding wire portion may be provided at least one of the primary winding and the secondary winding. Also, at least one of the primary auxiliary winding portion and the secondary auxiliary winding portion may not be provided.

It should be noted that the above-mentioned embodiment is merely illustrative in all aspects and does not limit this disclosure. All changes or modifications or their equivalents is to be fallen within the scope of this disclosure.

What is claimed is:

1. A transformer comprising:
a core portion, which forms a magnetic circuit;
a coil bobbin, which has a winding core portion to be wound by a winding wire, and which is attached on the core portion;
a primary winding wire, which has a plurality of first divided winding wire portions that is divided in parallel; and
a secondary winding wire, which has a plurality of second divided winding wire portions that is divided in parallel,
wherein the plurality of first divided winding wire portions and the plurality of second divided winding wire portions are layered on the winding core portion,
wherein at least one of the first divided winding wire portions becomes a first layer which is closest to the winding core portion, and at least one of the other of the first divided winding wire portions is interposed between two of the second divided winding wire portions.

2. The transformer according to claim 1,
wherein the number of the first divided winding wire portions is the same as the number of the second divided winding wire portions, and
wherein each one of first divided winding wire portions and each one of second winding wire portions are alternatively layered.

3. The transformer according to claim 1,
wherein at least one of the primary winding wire and the secondary winding wire includes a series winding wire portion, which is connected in series to at least one of the first winding wire portion of the primary winding wire and the second winding wire portion of the secondary winding wire, and
wherein the series winding wire portion is layered at an outer side of the plurality of first divided winding wire portions and the plurality of first divided winding wire portions.

4. The transformer according to claim 1, further comprising
an auxiliary winding portion, which is provided to at least one of a primary side and a secondary side,
wherein the auxiliary winding portion is layered at an outer side of the plurality of first divided winding wire portions and the plurality of first divided winding wire portions.
